(19) United States
(12) Patent Application Publication
(10) Pub. No.: US 2024/0300546 A1
(43) Pub. Date: Sep. 12, 2024

(54) RAIL VEHICLE

(71) Applicant: HITACHI, LTD., Tokyo (JP)

(72) Inventors: Takahiro CHOUNO, Tokyo (JP); Yuuki HASHIMOTO, Tokyo (JP); Yoshiaki SUGII, Tokyo (JP); Rikuto YATABE, Tokyo (JP); Hiroki TSUNODA, Aichi (JP); Ryutaro IMAKOMA, Aichi (JP)

(73) Assignee: HITACHI, LTD., Tokyo (JP)

(21) Appl. No.: 18/596,871

(22) Filed: Mar. 6, 2024

(30) Foreign Application Priority Data
Mar. 8, 2023 (JP) 2023-035353

(51) Int. Cl. B61D 17/18; B61D 17/04; B61D 17/08; B61D 17/12; B61D 25/00; B61D 33/00

(52) U.S. Cl. CPC B61D 17/185; B61D 17/08; B61D 25/00; B61D 33/005; B61D 17/041; B61D 17/12

(57) ABSTRACT

Provided is a rail vehicle that can promote a weight reduction of the rail vehicle by providing a film body in a side film or a ceiling film, can ensure a large vehicle inner space, can prevent the occurrence of stains, scratches, and the like. The rail vehicle includes an underframe including a floor portion, side structures that each have a window and are erected along a longitudinal direction of the side structures at both end portions in a width direction of the underframe, and side films provided along surfaces of the side structures on a vehicle inner side. Each of the side films has a window opening portion at a portion corresponding to the window, and a window frame portion that presses a peripheral edge portion of the window opening portion toward the side structure is provided.

### CROSS-REFERENCE TO RELATED APPLICATIONS

The present application claims priority to Japanese Patent Application No. 2023-035353, filed Mar. 8, 2023. The contents of this application are incorporated herein by reference in their entirety.

### TECHNICAL FIELD

The present invention relates to a rail vehicle.

### BACKGROUND ART

A rail vehicle operated along a laid track generally has a hexahedral rail vehicle structure including an underframe serving as a floor surface, end structures erected on both end portions in a longitudinal direction of the underframe, side structures erected on both end portions in a width direction of the underframe, and a roof structure placed on upper end portions of the end structures and the side structure. An upper floor is provided on an upper surface of the underframe, and a seat or the like is provided on an upper surface of the upper floor. A heat insulating material and a sound insulating material are provided on a vehicle inner side of the side structures and the roof structure, and interior materials such as a side material and a ceiling material are provided in a manner of covering the heat insulating material and the sound insulating material, thereby providing a comfortable vehicle interior environment.

PTL 1 discloses a rail vehicle having a light interior material that can reduce the number of components and can reduce manufacturing steps related to work of positioning side structures, a roof structure, and an interior material. Such a rail vehicle includes an underframe, an upper floor that is provided on an upper surface of the underframe and serves as a floor portion, side structures erected on end portions in a width direction of the underframe, a roof structure placed on upper end portions of the side structures, side films provided on a vehicle inner side of the side structures, and a ceiling film provided on a vehicle inner side of the roof structure.

### CITATION LIST

### Patent Literature

PTL 1: JP2019-214269A

### SUMMARY OF INVENTION

### Technical Problem

According to the rail vehicle, the rail vehicle includes the side films that function as interior materials provided on the vehicle inner side of the side structures, and the ceiling film that functions as an interior material provided on the vehicle inner side of the roof structure, and thus the number of components can be reduced and a weight reduction can be expected.

However, generally, a cross-sectional shape of the side structure that intersects a rail direction slightly bulges from a vehicle inner side toward a vehicle external side. Therefore, when an upper end edge of the side film is fixed to an upper portion of the side structure and a lower end edge of the side film is fixed to a lower portion of the side structure, an available vehicle inner space may become small because a central portion in a height direction of the side film does not extend along a surface of the side structure on the vehicle inner side and protrudes toward a central portion in a width direction of the rail vehicle inside the rail vehicle. Further, a film body that is excellent in weight reduction has incombustibility, air permeability, and flexibility and is excellent in weight reduction, but is likely to be stained or scratched when a passenger or the like frequently touches the film body.

An object of the invention is to provide a rail vehicle that can promote a weight reduction of the rail vehicle by providing a film body in a side film or a ceiling film, can ensure a large vehicle inner space, can prevent the occurrence of stains, scratches, and the like.

### Solution to Problem

In order to achieve the above object, a typical rail vehicle according to the invention includes:
an underframe including a floor portion;
side structures that each have a window and are erected along a longitudinal direction at both end portions in a width direction of the underframe; and
side films provided along surfaces of the side structures on a vehicle inner side, in which
each of the side films has a window opening portion at a portion corresponding to the window, and
a window frame portion that presses a peripheral edge portion of the window opening portions toward the side structure is provided.

### Advantageous Effects of Invention

According to the invention, it is possible to provide a rail vehicle that can promote a weight reduction of the rail vehicle by providing a film body in a side film or a ceiling film, can ensure a large vehicle inner space, can prevent the occurrence of stains, scratches, and the like.

Problems, configurations, and effects other than those described above will become apparent by description of the following embodiments.

### BRIEF DESCRIPTION OF DRAWINGS

FIG. 1 is a side view showing a railway vehicle.

FIG. 2 is a cross-sectional view (a cross-sectional view taken along a line A-A in FIG. 1) intersecting a longitudinal direction of the railway vehicle.

FIG. 3 is a cross-sectional view (an enlarged view of a part B in FIG. 2) showing a side structure and a side interior portion of the railway vehicle and intersecting a longitudinal direction of a seat.

FIG. 4 is a view (a view taken along arrows C in FIGS. 2 and 3) showing a surface of the side structure on a vehicle inner side of the railway vehicle as viewed from a center line F of a central portion in a width direction of the railway vehicle.

### DESCRIPTION OF EMBODIMENTS

Hereinafter, embodiments of a rail vehicle according to the invention will be described with reference to the drawings. First, directions are defined in order to describe a configuration of a rail vehicle. A longitudinal direction of the rail vehicle is defined as an x direction, a width direction of the rail vehicle is defined as a y direction, and a height direction of the rail vehicle is defined as a z direction. Hereinafter, directions may be simply referred to as the x direction, the y direction, and the z direction.

The rail vehicle is a vehicle operated along a laid track, and includes a railway vehicle, a monorail vehicle, a new transportation system vehicle, a streetcar, or the like. Hereinafter, a railway vehicle will be described as a representative example of a rail vehicle.

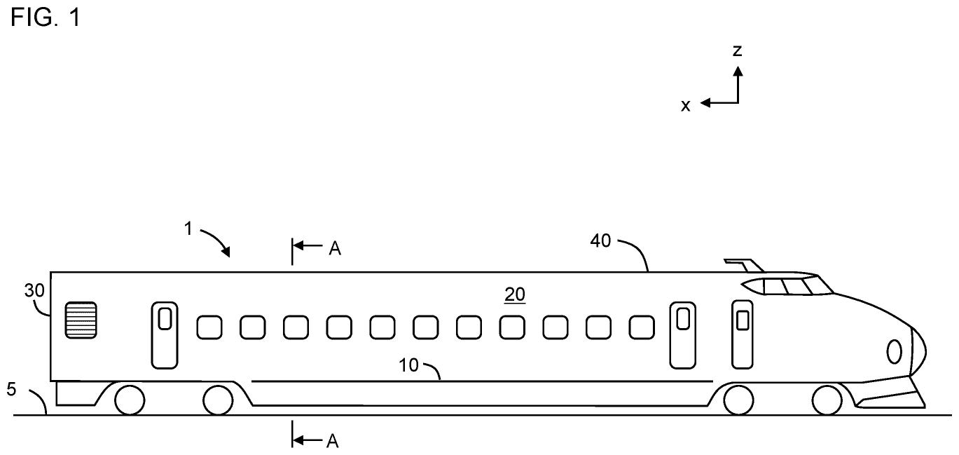

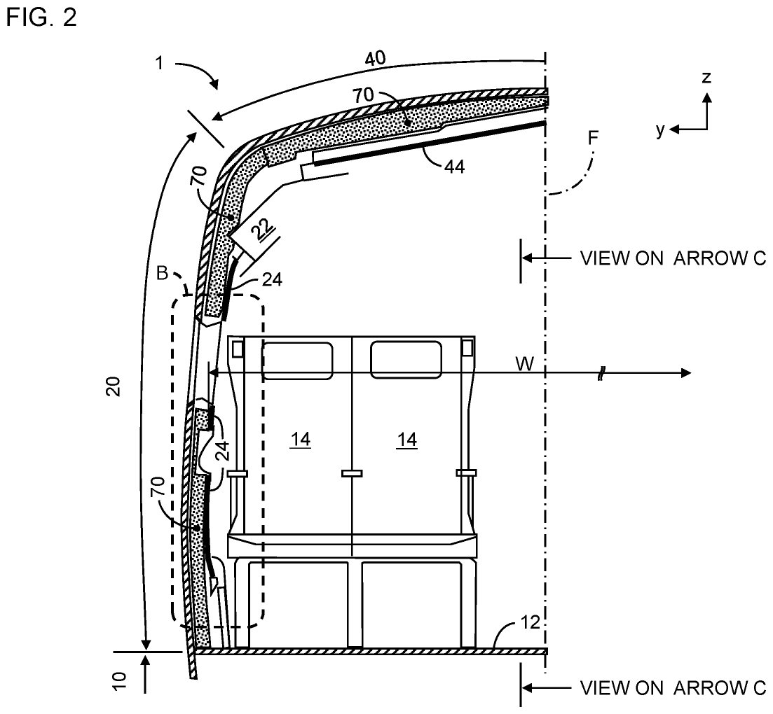

FIG. 1 is a side view showing a railway vehicle, and FIG. 2 is a cross-sectional view (a cross-sectional view taken along a line A-A in FIG. 1) intersecting a longitudinal direction of the railway vehicle. A railway vehicle 1 includes a hexahedral railway vehicle structure including an underframe 10 serving as a floor portion, side structures 20 erected on both end portions in the y direction of the underframe 10, an end structure 30 (including a head structure) erected on an end portion in the x direction of the underframe 10, and a roof structure 40 placed on upper end portions of the side structures 20 and the end structure 30, and the railway vehicle 1 includes a pair of bogies that support lower surfaces of both end portions in the x direction of the railway vehicle structure. The bogies support the railway vehicle structure and move along a track 5.

The railway vehicle 1 includes an upper floor 12 on an upper surface of the underframe 10, and seats 14 are provided on an upper surface of the upper floor 12. On a vehicle inner side of the roof structure 40, a heat insulating material (a sound absorbing material) 70 and a ceiling film 44 are provided in this order from a surface of the roof structure 40 on the vehicle inner side. In general, the heat insulating material 70 also has a sound absorbing property in addition to heat insulation. Similarly, the heat insulating material 70 and a side film 24 are provided in this order from a surface of the side structure 20 on the vehicle inner side. A luggage rack 22 on which luggage or the like is placed is provided at a portion where the ceiling film 44 and the side film 24 intersect with each other (an upper portion in the z direction of the side structure 20).

The ceiling film 44 and the side film 24 have a smaller weight per unit area than that of a decorative plate and is excellent in weight reduction, but cannot autonomously maintain shapes due to low rigidity. Therefore, one end edge of the ceiling film 44 or the side film 24 is fixed to the roof structure 40, the side structure 20, or the like, and the other end edge of the ceiling film 44 or the side film 24 is fixed to the roof structure 40, the side structure 20, or the like via an elastic body.

In this case, since tension of the elastic body is constantly applied to the ceiling film 44 or the side film 24, it is possible to prevent the ceiling film 44 or the side film 24 from sagging or wrinkling. One end portion or the other end portion of the ceiling film 44 or the side film 24 may be connected to the luggage rack 22 provided at a connection portion between an end portion in the y direction of the roof structure 40 and an end portion in the z direction of the side structure 20.

A film body provided in the ceiling film 44 or the side film 24 of the railway vehicle has a stain resistant property that makes the film body less likely to be stained, has incombustibility that can prevent the occurrence and spreading of predicted fire, has air permeability that contributes to a reduction in vehicle interior noises by attenuating the vehicle interior noises in a process of passing through the film body, and further has flexibility that prevents reflection of a sound on a surface of the film body to attenuate vehicle interior noises without causing any problem even when a passenger or the like touches the film body.

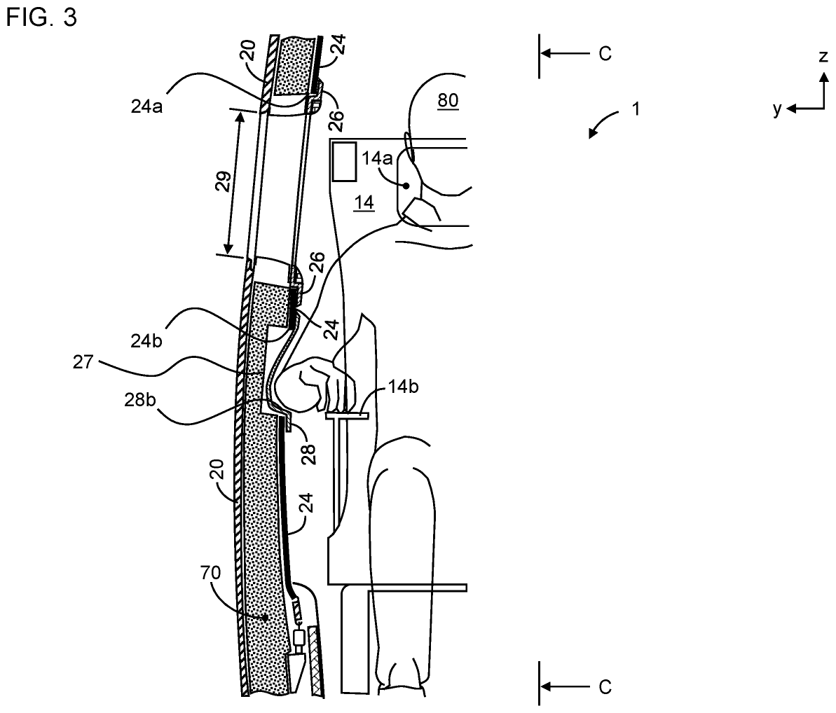

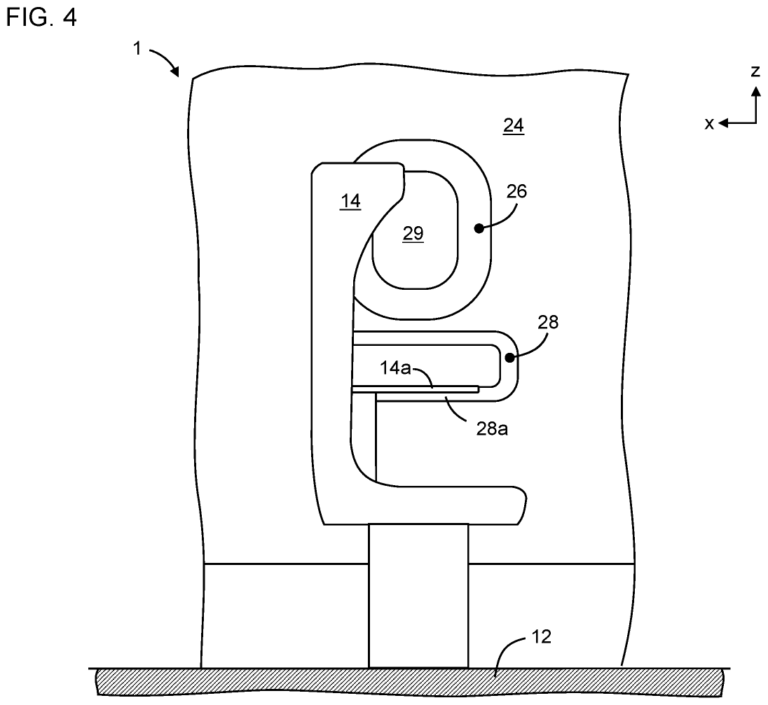

FIG. 3 is a cross-sectional view (an enlarged view showing a part B in FIG. 2) showing a side structure and a side interior portion of the railway vehicle and intersecting a longitudinal direction of a seat, and FIG. 4 is a view (a view taken along arrows C in FIGS. 2 and 3) showing a surface of the side structure on the vehicle inner side of the railway vehicle as viewed from a center line F of a central portion in the width direction of the railway vehicle.

The side structure 20 is formed of an extruded member or the like made of a lightweight aluminum alloy, and has a window 29 at a height of a head of each passenger 80 seated in the seat 14 from the upper floor 12. A cross-sectional shape of the side structure 20 intersecting the x direction is a shape in which a substantial central portion in the z direction of the side structure 20 bulges toward a vehicle external side of the railway vehicle 1 (see FIG. 2).

The heat insulating material 70 is provided on a surface of the side structure 20 on the vehicle inner side, and the side film 24 is provided in a manner of covering the heat insulating material 70 from a lower portion of the luggage rack 22 provided on an upper portion of the side structure 20 to the vicinity of the upper floor 12 at a lower portion of the side structure 20.

The seat 14 having a head rest 14a for holding a head of a passenger or the like and an armrest portion 14b for placing an elbow of a passenger or the like is provided on an upper surface of the upper floor 12 inside the railway vehicle 1.

The side film 24 has a window opening portion 24a located at a position corresponding to the window 29 and at a position at substantially the same height as the head rest 14a of the seat 14, and an armrest opening portion 24b located at substantially the same height as the armrest portion 14b of the seat 14. The window opening portion 24a is preferably smaller than an outer edge shape of a window frame portion 26, and the armrest opening portion 24b is preferably smaller than an outer edge shape of an armrest frame portion 28.

In a process of fixing the window frame portion (also referred to as a window frame) 26 to the window 29 of the side structure 20, a peripheral edge portion of the window opening portion 24a of the side film 24 provided at the same height as the head rest 14a is interposed between the vicinity of a peripheral edge of the window frame portion 26 and the heat insulating material 70, and is displaced (pressed) toward the side structure 20 (a surface on the vehicle inner side) by the window frame portion 26. Similarly, in a process of fixing the armrest frame portion (also referred to as an armrest frame) 28 to a side of the side structure 20, a peripheral edge portion of the armrest opening portion 24b of the side film 24 provided at the same height as the armrest portion 14b is interposed between the vicinity of a peripheral edge of the armrest frame portion 28 and the heat insulating material 70, and is displaced (pressed) toward a surface of the side structure 20 on the vehicle inner side by the armrest frame portion 28. Accordingly, the side film 24 is attached along an inner side surface of the curved heat insulating material 70.

The armrest frame portion 28 includes a flange portion that presses a peripheral edge of the window opening portion 24a of the side film 24, and a recessed portion 27 that has the flange portion at a peripheral edge and protrudes toward the side structure 20. The recessed portion 27 has a shape in which a lower portion in the z direction of the recessed portion 27 is closer to the side structure 20 than an upper portion in the z direction of the recessed portion 27 so that a part of an elbow of the passenger 80 or the like can be accommodated. It is preferable that a cross section of the recessed portion 27 intersecting the x direction draws a smooth circular arc in accordance with a shape of an arm of the passenger 80. A lower portion 28a of the armrest frame portion that is a bottom portion (a bottom surface) of a lower portion in the z direction of the recessed portion 27 has a substantially continuous surface 28b on an upper surface of the armrest portion 14b of the seat 14. Here, “substantially continuous” refers to that a height difference between closest portions of both surfaces in the z direction is within 10 mm.

Since the armrest portion 14b of the seat 14 and the surface 28b of the lower portion 28a of the armrest frame portion are aligned at substantially the same height, the passenger 80 or the like can have a wide elbow movement range from the armrest portion 14b to the lower portion 28a of the armrest frame portion, and therefore the passenger 80 or the like is less likely to feel uncomfortable.

### Effects

As shown in FIG. 2, the side structure 20 is formed such that a central portion in the z direction of the side structure 20 bulges from the vehicle inner side of the railway vehicle 1 toward the vehicle external side with a large radius of curvature in a cross section of the side structure 20 intersecting the x direction. Therefore, when an upper end edge in the z direction of the side film 24 is fixed to an upper portion in the z direction of the side structure 20 (or a lower portion of the luggage rack 22) and a lower end portion edge in the z direction of the side film 24 is fixed to a lower portion in the z direction of the side structure 20, a central portion in the z direction of the side film 24 is separated from a surface of the side structure 20 on the vehicle inner side and comes close to the center line F in the x direction of the railway vehicle 1, and a dimension of an available cabin space in the y direction may be small.

On the other hand, according to the configuration of the embodiment, the window opening portion 24a in the upper portion of a central portion in the z direction of the side film 24 is pressed toward the side structure 20 side by the window frame portion 26, and the armrest opening portion 24b in the lower portion of the central portion in the z direction of the side film 24 is pressed toward the side structure side 20 by the armrest frame portion 28. Therefore, it is possible to prevent a situation in which the side film 24 is separated from the surface of the side structure 20 on the vehicle inner side (or the heat insulating material 70) and comes close to a central portion in the y direction of the railway vehicle 1. Accordingly, it is possible to ensure a large available maximum dimension W in the y direction inside the railway vehicle 1, and thus it is possible to improve comfort of a passenger or the like with an ample cabin space.

An upper surface of the armrest portion 14b of the seat 14 and the surface 28b of the lower portion 28a of the armrest frame portion 28 constitute a substantially continuous surface. Therefore, the passenger 80 or the like can move an elbow in a wide range, and thus it is possible to provide a highly comfortable vehicle interior environment.

The side film 24 (the ceiling film 44) has a film body having incombustibility, air permeability, and flexibility, is excellent in weight reduction, but is likely to be stained or scratched when the passenger 80 or the like frequently touches the film body. There is a high possibility that an elbow portion of the passenger 80 or the like who is seated near a window touches the side film 24 at a high frequency. Since the armrest frame portion 28 is provided in the side film 24 at a portion where there is a high possibility that an elbow of the passenger 80 or the like frequently touches the side film 24, the elbow of the passenger 80 or the like is prevented from directly coming into contact with the side film 24, and thus the occurrence of stains and scratches of the side film 24 can be prevented. For example, when the recessed portion 27 or the armrest frame portion 28 is made of a relatively hard resin, cleaning is easy.

Therefore, according to the invention, it is possible to provide the railway vehicle that can promote a weight reduction of a rail vehicle by providing the film body in the side film or the ceiling film, can ensure a large vehicle inner space, can prevent the occurrence of stains, scratches, and the like.

The present specification includes the following disclosure of inventions.

### (First Aspect)

A rail vehicle includes:
an underframe including a floor portion;
side structures that each have a window and are erected along a longitudinal direction at both end portions in a width direction of the underframe; and
side films provided along surfaces of the side structures on a vehicle inner side, in which
each of the side films has a window opening portion at a portion corresponding to the window, and
a window frame portion that presses a peripheral edge portion of the window opening portion toward the side structure is provided.

### (Second Aspect)

The rail vehicle according to the first aspect, further includes:
a seat that is placed on the floor portion and that has an armrest portion, in which
the side film has an armrest opening portion at a portion corresponding to the armrest portion, and
an armrest frame portion that presses a peripheral edge portion of the armrest opening portion toward the side structure is provided.

### (Third Aspect)

In the rail vehicle according to the second aspect,
an upper surface of the armrest portion and a surface of a lower portion of the armrest frame portion are substantially continuous with each other.

### (Fourth Aspect)

In the rail vehicle according to the third aspect,
a cross-sectional shape of the side structure that intersects the longitudinal direction is a shape bulging from a vehicle inner side to a vehicle external side of the rail vehicle.

### (Fifth Aspect)

In the rail vehicle according to the fourth aspect,
an upper end edge of the side film is fixed to an upper end portion of the side structure, and a lower end edge of the side film is fixed to a lower end portion of the side structure.

### (Sixth Aspect)

In the rail vehicle according to the fifth aspect,
one of the upper end edge and the lower end edge of the side film is connected to the side structure via an elastic body, and tension is applied to the side film.

### (Seventh Aspect)

In the rail vehicle according to any one of the first to sixth aspects,
an upper end portion of the side film is connected to a luggage rack fixed to an upper portion of the side structure.

### REFERENCE SIGNS LIST

1: railway vehicle
5: track
10: underframe
12: upper floor
14: seat
14a: head rest
14b: armrest portion
20: side structure
22: luggage rack
24: side film
24a: window opening portion
24b: armrest opening portion
26: window frame portion
27: recessed portion
28: armrest frame portion
28a: lower portion of armrest frame
28b: surface
29: window
30: end structure
40: roof structure
44: ceiling film
70: heat insulating material (sound absorbing material)
80: passenger
x: rail (longitudinal) direction
y: sleeper (width) direction
z: height direction
F: center line (part)
W: widthwise dimension between armrest portions

1. A rail vehicle comprising:
an underframe including a floor portion;
side structures that each have a window and are erected along a longitudinal direction at both end portions in a width direction of the underframe; and
side films provided along surfaces of the side structures on a vehicle inner side, wherein
each of the side films has a window opening portion at a portion corresponding to the window, and
a window frame portion that presses a peripheral edge portion of the window opening portion toward the side structure is provided.

2. The rail vehicle according to claim 1, further comprising:
a seat that is placed on the floor portion and that has an armrest portion, wherein
the side film has an armrest opening portion at a portion corresponding to the armrest portion, and
an armrest frame portion that presses a peripheral edge portion of the armrest opening portion toward the side structure is provided.

3. The rail vehicle according to claim 2, wherein
an upper surface of the armrest portion and a surface of a lower portion of the armrest frame portion are substantially continuous with each other.

4. The rail vehicle according to claim 3, wherein
a cross-sectional shape of the side structure that intersects the longitudinal direction is a shape bulging from a vehicle inner side to a vehicle external side of the rail vehicle.

5. The rail vehicle according to claim 4, wherein
an upper end edge of the side film is fixed to an upper end portion of the side structure, and a lower end edge of the side film is fixed to a lower end portion of the side structure.

6. The rail vehicle according to claim 5, wherein
one of the upper end edge and the lower end edge of the side film is connected to the side structure via an elastic body, and tension is applied to the side film.

7. The rail vehicle according to claim 6, wherein
an upper end portion of the side film is connected to a luggage rack fixed to an upper portion of the side structure.
